(19) United States
(12) Patent Application Publication
(10) Pub. No.: US 2006/0120941 A1
(43) Pub. Date: Jun. 8, 2006

(54) Silica support material, its application in a polyalkene catalyst, and its preparation process

(76) Inventors: Jianfeng Chen, Beijing (CN); Jirui Song, Beijing (CN); Haikui Zou, Beijing (CN); Lixiong Wen, Beijing (CN)

Correspondence Address: HASSE & NESBITT LLC, 7550 CENTRAL PARK BLVD., MASON, OH, 45040, US

(21) Appl. No.: 11/291,154

(22) Filed: Dec. 1, 2005

(30) Foreign Application Priority Data
Dec. 2, 2004 (CN) CN 200410098068.4

(51) Int. Cl. C01B 33/12

(52) U.S. Cl. 423/335

(57) ABSTRACT

An SiO₂ support material used in a polyolefin catalyst, which consists of a hollow silica particle having a wall of some thickness and a process to prepare the silica mesoporous material above and the agglomerated hollow silica particulate, comprising the steps of: taking nanometer-sized calcium carbonate as inorganic template, or taking PMMA, PS, PU as organic template, then making silica grow and synthesize on the surface of the template, and obtaining the hollow silica material by removing the template. The above hollow silica can be used as raw material to prepare an agglomerated hollow silica particulate by particle shaping. Such material has a certain specific surface area, a wide pore size distribution and a large pore volume, and a uniform particle size distribution, so it can be used in many applications such as adsorption material, catalyst material, wave-absorbing material, ceramic material, sensitive material, magnetic material and the like, especially widely used in the polyolefin catalyst.

### FIELD OF THE INVENTION

This invention relates to a hollow silica particle and an agglomerated hollow silica, as well as a preparation process thereof. This invention also relates to a process of aggregating the single hollow silica particle into agglomerated particulate by an oil-ammonia shaping method and a spray drying shaping method, and the produced agglomerated hollow silica particulate. In addition, this invention relates to a catalyst product prepared by loading the catalyst to the agglomerated hollow silica particulate, and application thereof in alkene polymerization.

### BACKGROUND OF THE INVENTION

SiO₂ is widely used in many kinds of industries such as chemical engineering, ceramics, paints, papermaking, catalyst support and so on. The traditional preparation of silica is to precipitate SiO₂ from a solution of soluble glass (Na₂SiO₃). And the primary process of precipitation is to introduce carbon dioxide or an acid solution into the solution of Na₂SiO₃. However, SiO₂ prepared by this method is mostly white carbon black, which is a solid microsphere with a small specific surface area, and when used as catalyst support, it has a non-even distribution of the loaded catalyst. Especially when it is used in a catalyst of alkene polymerization, the amount of catalyst promoter Methyl Aluminum Oxyalkane (MAO) has to be properly increased in order to enhance the catalytic activity, as a result it causes increased ash in the polymer product and thus it is difficult to promote the catalytic activity and polymer performance efficiently. Jin Suk Chung et al. reported a process of mixing an ordinary silica gel with MgCl₂ to prepare a support of composite catalyst to load Ziegler-Natta/metallocene composite catalyst (See, J. Molecular Cat. A: Chem. 1999, 144, 61-69).

A preparation method of a nanometer composite material of CaCO₃/SiO₂ is described in detail in Chinese Pat No. 02107391.0. A layer of SiO₂ can be coated on the surface of calcium carbonate, and according to the size and the shape of the calcium carbonate, the particle size, the wall thickness and the particle shape of the hollow silica can also be regulated. Chinese Pat No. 02160383.9 in detail describes a preparation process of a mesoporous hollow silica material by using nanometer calcium carbonate as template, wherein the mesoporous hollow silica material has a particle size from 50 nm to 120 nm, a wall thickness from 10 nm to 15 nm, and an average pore size from 2 nm to 5 nm. However, what relates to the preparation of an agglomerated hollow silica from single hollow silica particle and to the application of the agglomerated hollow silica as catalyst support to load metal catalyst in alkene polymerization has not been reported.

Therefore, one of the aspects of this invention is to prepare hollow SiO₂ by a process of taking nanometer CaCO₃ or organic high polymers polymethylmethacrylate (PMMA), polystyrene (PS) or polyurethane (PU) as template, and coating the template with a silicon-containing aqueous solution or organic compound of silicon.

Another aspect of this invention is to make single hollow silica particle into agglomerated hollow silica particle.

One more aspect of this invention is to provide a catalyst product, in which the agglomerated hollow silica particle acts as support to load a catalyst, and the application thereof in the catalytic polymerization.

One more aspect of this invention is to provide a process of preparing the said single hollow silica particle, the agglomerated hollow silica particle, and a method to load a catalyst.

### SUMMARY OF THE INVENTION

This invention relates to a hollow silica particle, which has a hollow structure.

This invention relates to an agglomerated hollow silica particulate formed from the hollow silica particle described above, which comprises a large amount of the single particles of hollow silica.

This invention also relates to a preparation process of the hollow silica particle, comprising the steps of: mixing a suspension of calcium carbonate particle or a suspension of polymethylmethacrylate (PMMA) particle, polystyrene (PS) particle, or polyurethane (PU) particle with a certain amount of silicon-containing aqueous solution or organic compound of silicon in a reactor; stirring the resultant solution continuously at a controlled temperature and pH until the silicon is precipitated completely; and after aging for a period of time, then filtering, washing, drying, sieving, calcining, dissolving in acid, filtering, washing and drying to produce the hollow-structured silica particle.

This invention relates to a preparation process of the said agglomerated silica particulate, comprising the steps of: dispersing the hollow silica particle, shaping by an oil-ammonia shaping method, and filtering, drying, sieving, and calcining to obtain agglomerated silica particle; or spraying by spray drying method with a spray drier and calcining to obtain the agglomerated silica particulate.

This invention also relates to use the said agglomerated hollow silica particulate to load nonmetallocene catalyst for use in alkene polymerization.

### BRIEF DESCRIPTION OF THE INVENTION

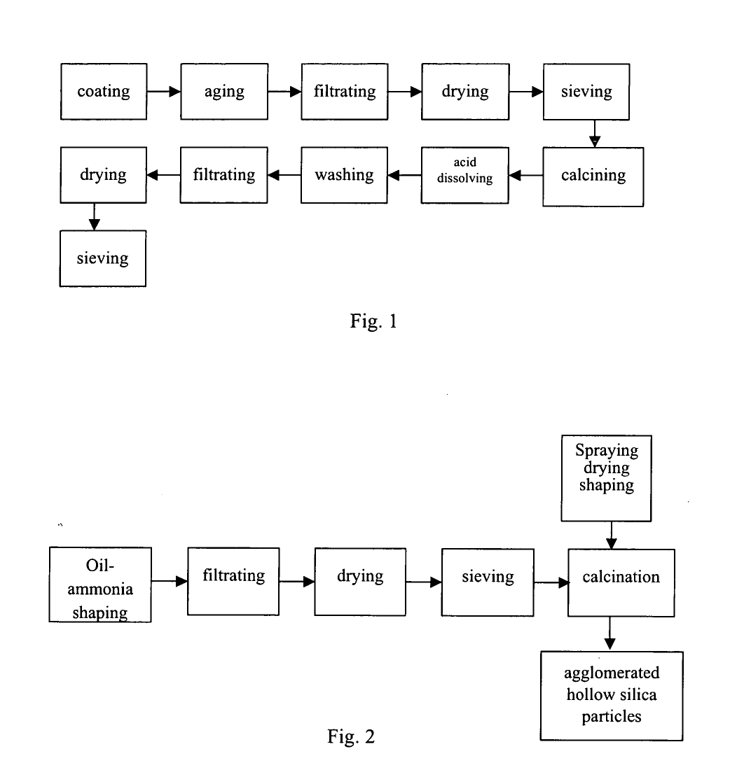

FIG. 1 shows a schematic flowchart of the process of preparing a nanometer hollow silica particle.

FIG. 2 shows a schematic flowchart of the process of preparing an agglomerated nanometer hollow silica particulate.

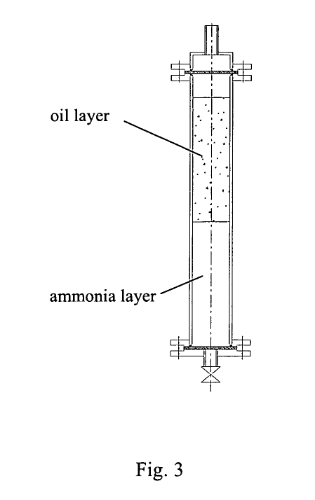

FIG. 3 shows oil-ammonia shaping equipment for preparing the agglomerated nanometer hollow silica particulate.

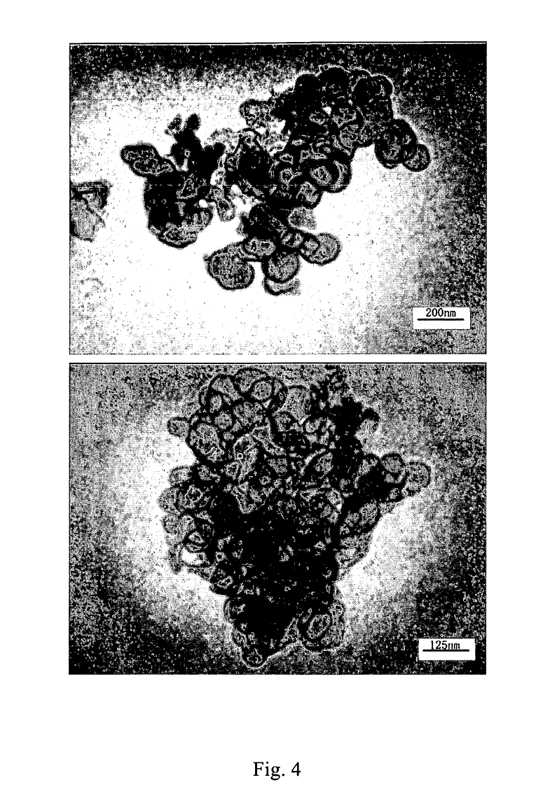

FIG. 4 is a transmission electron micrograph (TEM) of the single nanometer hollow silica particle, in both the top and bottom panels, at the scale indicated.

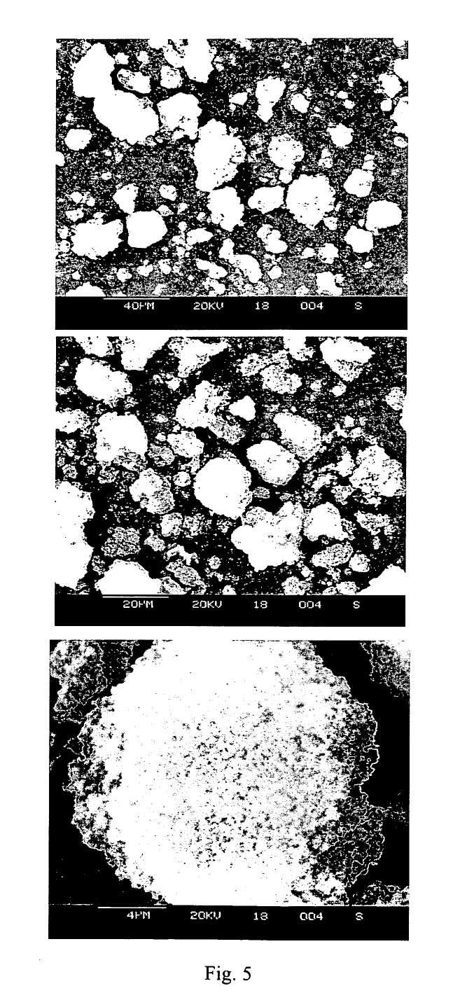

FIG. 5 is a scanning electron micrograph (SEM) of the agglomerated nanometer hollow silica particulate, in the top, middle and bottom panels, at progressively greater magnification as the respective scales indicate.

### DETAILED DESCRIPTION OF THE INVENTION

According to the first aspect of the present invention, a hollow silica particle is provided which has a specific surface area from 500 m²/g to 1500 m²/g, preferably from 500 to 1000 m²/g, such as 600-900 m²/g, or 1050-1250 m²/g; a pore volume from 0.01 ml/g to 2.0 ml/g, preferably from 0.2 ml/g to 1.5 ml/g; and a particle size from 30 to 500 nm, preferably from 40 to 100 nm. The hollow silica particle of the invention is preferably has a substantially spherical shape.

According to the second aspect of the present invention, a preparation process of the hollow silica particle is provided. Nanometer-sized calcium carbonate or nanometer-sized PMMA or nanometer-sized PS or nanometer-sized PU is selected as a template, and SiO₂ is selected as a coating layer. The term “nanometer-sized” means a particle of less than 1000 nanometers in diameter, or its equivalent. The preparation process comprises the steps of: mixing a suspension of particles selected from the group consisting of calcium carbonate particle, PMMA particle, PS particle, and PU particle, with a certain amount of a silicon-containing solution selected from the group consisting of a silicon-containing aqueous solution or an organic compound of silicon, in a reactor; stirring the resultant solution continuously at a controlled temperature and pH until the silicon is precipitated completely; and after aging for a period of time, then filtering, washing, drying, sieving, calcining, and optionally dissolving the shell-core particle in acid, then filtering, washing and drying to produce the single hollow silica particles as a powder.

In the present invention, it is preferred to select PMMA, PS or PU as an organic template to prepare the composite material with a core-shell structure, because the nanometer silica particles can be obtained as a product after removing the template by calcining the composite material with a core-shell structure directly. Comparing with nanometer calcium carbonate used as template, it does not need the process of acid dissolving, washing and drying, and so the cost of production is reduced.

The reasons for choosing PMMA, PS and PU as a template are that these chosen polymer resins are dispersed well in emulsion without any agglomeration between each other, and a majority of the particles appear to be dispersed separately while the particle size is very uniform with a narrow particle size distribution, therefore, the particle size of the prepared hollow silica is relatively uniform and is easy to control in the preparing process. However, the majority of particles made from polyterephthalic glycol ester (PET) or polyvinyl-chloride (PVC) are agglomerated and dispersed unevenly with a wide particle-size distribution, and will result in an uneven particle size of the prepared hollow silica particles and in difficulty to control in the preparing process when used as template agent. Furthermore, the decomposition of polyvinyl-chloride produces abundant virulent chloride gas, which not only affects the preparation of the hollow silica but also can have a negative impact on the environment. Therefore, PMMA, PS and PU are selected as preferred template agents in the preparation of hollow silica in the present invention.

In the present invention, the particle size of the calcium carbonate, PMMA, PS and PU depends on the expected particle size of hollow silica products. The particle size of calcium carbonate is less than 100 nm, preferably from 30 nm to 50 nm generally. The particle size of PMMA and PS is from 100 nm to 400 nm, preferably from 200 nm to 300 nm. The particle size of PU is from 30 nm to 100 nm, preferably from 40 nm to 60 nm. The shape of calcium carbonate is spherical or cubic, and the shape of PMMA, PS and PU is substantially spherical.

In the present invention, the silicon-containing solution is a solution of water-soluble silicate such as Na₂SiO₃, K₂SiO₃ and organic silicon ester which can be hydrolyzed to silica such as tetraethyl orthosilicate (TEOS) and so on.

In the said preparation of this invention above the reaction system for mixing the template agent of calcium carbonate particle or PMMA, PS, PU particle with the silicon-containing aqueous solution or organic compound of silicon is at the temperature from 20° C. to 100° C. and at pH value of from 5 to 13.

In the said process above, the reaction time is from 1 hour to 24 hours. The aging time is from 0 hour to 10 hours. The calcining temperature of the composite material is from 400° C. to 800° C. The calcining time is from 1 hour to 10 hours. The pH value at which the calcium carbonate-silica composite material is dissolved in acid after calcination is less than 1 and the dissolving time is from 2 hours to 10 hours.

In an example according to the second aspect of the present invention, nanometer calcium carbonate slurry having a concentration of 80 g·L⁻¹ is added to the reactor and the reaction temperature of the slurry is controlled in the range from 20° C. to 100° C., preferably from 60° C. to 80° C. After the reaction temperature is reached, the silicon-containing aqueous solution is added within two hours with continuously stirring. Diluted hydrochloric acid having a concentration of 10% by weight is drop-wise added into the reaction system at the same time. The pH value of the reacting system is from 5 to 13, preferably from 7.5 to 9.5. The aging time is from 1 hour to 6 hour, preferably from 2 to 5 hour. After the aging step of the mixture is over, the hollow silica powder can be obtained by filtrating, washing, drying, sieving, calcining, and then acid dissolving, filtrating, washing, drying and sieving.

In this process, the calcining temperature is from 400° C. to 800° C. The calcining time is 1 hour to 10 hours. The temperature is increased in a speed of 1° C. to 5° C. per minute. The acid used during the acid dissolving is selected from hydrochloric acid, nitric acid, acetic acid or the like. The pH value of the acid dissolving is less than 1 and the dissolving time is from 2 hours to 10 hours. The drying temperature is from 95° C. to 120° C. The drying time is 4 hours to 16 hours.

In another example according to the second aspect of the present invention, a process that PMMA, PS or PU is used as template to prepare hollow silica particle is provided. Silicon-containing organic compound is added to a suspension of the said template agent and ammonia water or dilute hydrochloric acid as pH regulating agent is then added to adjust the pH value of the reaction system. The reaction time is from 2 hours to 12 hours, preferably from 6 hours to 12 hours. The pH value of the system is controlled in the range from 2 to 12. The aging time is from 2 hours to 12 hours, preferably from 6 to 10 hours. After the aging step of the reaction system is over, the hollow silica particles as a powder can be obtained by filtrating, washing, drying, sieving and calcining.

In this process, the drying temperature is from 60° C. to 120° C. The drying time is 4 hours to 16 hours. The calcining temperature is from 400° C. to 500°C. and the temperature is increased in a speed of 1° C. to 5° C. per minute. The calcining time is 2 hours to 8 hours.

According to the third aspect of the present invention, an agglomerated hollow silica particulate material is provided, which has a specific surface area from 50 m²/g to 600 m²/g, preferably from 100 m²/g to 400 m²/g; a pore volume from 0.1 ml/g to 4 ml/g, preferably from 0.1 ml/g to 2 ml/g; a pore size from 4 nm to 30 nm, preferably from 10 nm to 40 nm; and a grain size from 5 μm to 70 μm, preferably from 10 μm to 50 μm.

The agglomerated hollow silica particulate material is formed by agglomeration of a large amount of single hollow silica particles, and has a spherical or irregularly spherical shape, a large pore volume and a wide pore size distribution.

According to the fourth aspect of the present invention, a process of preparing the agglomerated hollow silica particulate is provided, comprising the steps of: dispersing the hollow silica particles prepared above to turn into a colloid with deionized water and the obtained concentration of the colloid is from 5% to 12% by weight; adding the colloid to a shaping tube where the oil-ammonia length ratio is 1:1 in an adding speed from 3 ml to 7 ml per minute; and after the silica is shaped, filtrating, drying, sieving and calcining to obtain the agglomerated hollow silica particulate.

The term “agglomerated silica particluate” means an aggregate consisting of a large number of nanometer hollow silica particles, which has a particle size from 10 μm to 100 μm generally, and a spherical or irregularly spherical shape.

The shaping temperature of the present process is room temperature. The drying temperature is from 95° C. to 120° C. The drying time is 4 hours to 16 hours. The dried agglomerated silica particulate, as a powder, is sieved by a standard sieve of 100-200 mesh. The calcining temperature is from 400° C. to 600° C. which is increased in a speed of 1° C. to 5° C. per minute. The calcining time is from 2 hours to 10 hours.

A particular process according to the fourth aspect of the present invention includes the steps of:
(a) dispersing the hollow silica nanoparticle to turn into a colloid, then;
(b) drop-wise adding the colloid to a shaping column having an oil phase and a water phase to thereby agglomerate the silica particles to shape. The oil phase comprises one or more kinds of materials selected from kerosene, gasoline, officinal vaselinum, mineral vaselinum, transformer oil, machine oil, toluene, benzene, carbon tetrachloride, ether, octane, hexane, cyclohexane, heptane or the mixture thereof; and the aqueous phase is ammonia water.

The shaped silica particles are separated, dried, sieved, and calcinated to prepare the agglomerated hollow silica particulate.

In the said process above, the silica is dispersed to turn into the colloid with deionized water and the obtained concentration of the colloid is from 5% to 12% by weight. The preferred oil phase in the shaping column is kerosene and the preferred water phase is ammonia water. The oil-ammonia length ratio is 1:1.

According to the fifth aspect of the present invention, another process of preparing the agglomerated hollow silica particulate is provided, comprising the steps of:
(a) dispersing the hollow silica with absolute alcohol while polyvinyl alcohol (PVA) is added as an adhesive agent;
(b) spraying by a spray drier; and
(c) calcining to prepare the agglomerated hollow silica particulate.

In the said process above, the silica is dispersed with absolute alcohol and the obtained concentration is from 3% by weight to 10% by weight. An amount from 20 milliliters to 70 milliliters of polyvinyl alcohol at a concentration from 1% by weight to 5% by weight is added to the solution. The silica is added in a speed from 50 to 60 milliliters per minute.

The main function of polyvinyl alcohol is to bind the silica particles together and the polyvinyl alcohol can be removed by calcination in the end so as to obtain the agglomerated silica particulate. In place of polyvinyl alcohol, amylum can also be used as a binder.

In the present process, the flow rate of the high-purity nitrogen in the spray drier is 0.3˜0.5 m³/h. The inlet temperature of the spray drier is 110° C. to 130° C. and the outlet temperature is 160° C. to 180° C. The calcining temperature is 400° C. to 500° C. and the heating speed is 1° C. to 5° C. per minute. The calcining time is 2° C. to 8° C. hours.

According to the sixth aspect of the present invention, a catalyst product is provided which contains a catalyst and the agglomerated hollow silica particulate as a support, wherein the catalyst is a nonmetallocene catalyst, metallocene catalyst or Ziegler-Natta catalyst. The nonmetallocene catalyst is mainly ferro-metallocene catalyst, and the metallocene catalyst is mainly Zr-metallocene or Ti-metallocene catalysts such as Cp₂ZrMe₂, Cp₂HfMe₂, Cp₂TiCl₂, Cp₂ZrCl₂, Cp₂Ti(CH₃)Cl, Cp₂Zr(CH₃)Cl or Cp₂Hf(CH₃)Cl. The catalyst product above can also comprise a catalyst promoter chosen from methyl aluminum oxyalkane or trimethyl aluminum.

According to the seventh aspect of the present invention, a process is provided to load catalyst to the agglomerated hollow silica particulate prepared in the present invention.

In particular, the invention provides a process of loading catalyst, comprising:
(a) calcining the agglomerated silica particulate;
(b) diluting the catalyst promoter with toluene under the protection of highly pure nitrogen and loading it to the agglomerated silica particulate;
(c) then diluting the catalyst with methylene chloride and loading it to the agglomerated silica particle; and
(d) optionally, diluting the catalyst promoter with toluene under the protection of highly pure nitrogen and loading it to the said agglomerated silica particle.

In the process to load catalyst, the catalyst is selected from the group consisting of nonmetallocene catalyst, metallocene catalyst, and Ziegler-Natta catalyst. The nonmetallocene catalyst mainly is ferro-metallocene catalyst, metallocene catalyst, and Ziegler-Natta catalyst is mainly Zr-metallocene and Ti-metallocene catalysts such as Cp₂ZrMe₂, Cp₂HfMe₂, Cp₂TiCl₂, Cp₂ZrCl₂, Cp₂Ti(CH₃)Cl, Cp₂Zr(CH₃)Cl and Cp₂Hf(CH₃)Cl. The catalyst promoter can comprise methyl aluminum oxyalkane (MAO) or trimethyl aluminum.

In the process of loading a catalyst, the agglomerated silica particulate is calcinated under the following conditions: the calcining temperature is from 350° C. to 450° C., the heating speed is from 2° C. to 5° C. per minute, the calcining time is 2 hours to 6 hours; and cooled in vacuum to remove the adsorbed water and surface hydroxyl adsorbed by the silica.

In the process of loading a catalyst, toluene is purified by sodium under heated reflux at a temperature ranging from 110° C. to 120° C. and a reflux time from 5 hours to 8 hours; methylene chloride is purified by calcium hydride under heated reflux at a temperature ranging from 30° C. to 45° C. and a reflux time from 5 hours to 8 hours to remove the little water and oxygen contained in toluene and methylene chloride.

In the process of loading a catalyst, the catalyst promoter MAO is dispersed in toluene and loaded on the agglomerated hollow silica particulate by immersing. The loading temperature is from 50° C. to 60° C. and the loading time is from 5 hours to 8 hours.

The catalyst promoter MAO and the nonmetallocene catalyst are sensitive to water and oxygen, the contact to which may make the catalyst deteriorate and deactivate. Thus, the silica support and dilutent solvent should be dehydrated and deoxidated. The agglomerated silica particle is calcinated, and the catalyst promoter MAO is diluted with toluene and loaded to the silica under the protection of highly pure nitrogenthe; and the nonmetallocene catalyst is then diluted with methylene chloride and loaded to the agglomerated silica particulate.

According to the eighth aspect of the present invention, a process of loading nonmetallocene catalyst to the agglomerated hollow silica particulate is provided. In particular the steps are as follow: calcining the agglomerated hollow silica particle and cooling in vacuum; purifying toluene by sodium under reflux and diluting the catalyst promoter MAO with the purified toluene; purifying methylene chloride by calcium hydride under reflux and diluting the nonmetallocene catalyst with the purified methylene chloride; weighing a certain amount of the calcinated agglomerated silica particulate and adding into the said catalyst promoter MAO toluene solution to load catalyst by immersing. The silica support loading catalyst promoter can be obtained after filtering and washing. A certain amount of the nonmetallocene catalyst is weighed and dissolved with methylene chloride, then the promoter catalyst-loading silica is added to load the nonmetallocene catalyst by immersing. The supported nonmetallocene catalyst can be obtained after filtrating, washing and drying.

According to the ninth aspect of the present invention, an alkene polymerization is provided which is characterized by adding the supported catalyst of the present invention to a reactor and then introducing the alkene to carry on the polymerization to obtain the product of polyolefin, wherein the alkene is selected from the group consisting of ethylene, propylene, styrene, or a mixture thereof.

A particular process according to the eighth aspect of the present invention is as follow: 34.5 milligram of the catalyst-loading hollow silica is put into a 2-litre reactor. Ethylene gas is introduced, and the polymerization is then carried on under a certain temperature and pressure. The reaction pressure is 2 MPa. The reaction temperature is from 60° C. to 80° C. The reaction time is 1 to 3 hours.

The experiment study of the polymerization reaction shows that: a polymer was obtained by polymerization reaction, wherein the agglomerated hollow silica particulate was used as support to load nonmetallocene catalyst, and the total catalyst activity was 5768 times and the stacking density was 0.23 g/mL with a good particle morphology and a primary particle distribution in the range of 0.7 to 0.8 mm. No polyethylene wax with a low molecular weight was found.

As mentioned above, the present invention provides a process of preparing the hollow silica particle and the agglomerated hollow silica particulate, and provides the hollow silica particle materials and the agglomerated hollow silica particulate materials, and describes a process wherein the hollow silica is used as a support to load a nonmetallocene catalyst and to apply in polymerization. This kind of material has many desirable properties, such as small stacking density, large specific surface area, light weight, tunable pore size distribution and large pore volume, so it can be widely used in preparing catalysts, especially in preparing alkene polymerization catalysts.

The hollow SiO₂ has special properties that common SiO₂ does not possess because of its extra fine size together with its hollow and nanometer pore canal structure. For example, the active center of the catalyst can be loaded to the internal cavities and channels of the SiO₂ particle as catalyst support, thus the catalyst activity is enhanced as a result of the improvement of the dispersion of the catalyst active composition, and the catalyst dosage may be decreased. In the alkene polymerization reaction, the catalyst and the catalyst promoter are loaded to the silica used as catalyst support. During the course of polymerization, small molecules of alkene are scattered to the inner of the silica support. As the molecular chain is growing, the length of the molecular chain is gradually becoming bigger and finally the silica support is broken into many small silica particles. Then the alkene turns to polymerize and grow by taking those small particles as cores, and in the end all of the catalyst support, catalyst and catalyst promoter remain in the product, so the amount of the support and catalyst has a great effect on the polymerization activity and the property of the product. Because it is of formed from a huge amount of nanometer hollow silica, the agglomerated hollow silica particulate has a large pore volume, a wide pore size distribution and a large pore size, all of which makes a great benefit on loading the catalyst and catalyst promoter. The catalyst promoter MAO can improve the catalyst activity of the nonmetallocene catalyst, metallocene catalyst and Ziegler-Natta catalyst efficiently. Furthermore, because of having the special pore structure, the agglomerated hollow silica particle in a less amount compared with conventional silica gel support can load the same amount of catalyst, or in other words, the same amount of the silica support compared with the conventional silica gel support can load more catalyst, as a result, in the condition of identical catalyst activity, the ash remaining in the product may be decreased resulting in an increased property or yield of the product. In addition, the agglomerated hollow silica particulate can be used to load other common metal catalyst in the catalytic reaction or to prepare heat-insulating material or inorganic/organic composite material and so on.

The present invention is further illustrated by the following examples.

### EXAMPLE 1

2000 ml 0.8 mol/I calcium hydroxide suspension was placed in an agitating pot. Turning on the super gravity reactor (such as is described in U.S. Pat. No. 6,827,916, the disclosure of which is incorporated herein by reference) and the circulating pump for calcium hydroxide slurry with a flow rate controlled at 300 ml/min. The rotating speed of the super gravity reactor was set at 2000 r/min. After the system became stable, carbon dioxide was introduced at a flow rate of 0.3 m³/h. Reacting calcium hydroxide with carbon dioxide in the super gravity reactor proceeded with circulation between the agitating pot and the reactor. An on-line pH meter was used to detect the change of pH value of the system. The reaction temperature was 10° C. to 15° C. When the pH value became 7, the reaction reached the ending and was terminated, and the calcium carbonate slurry with a particle size of 30 to 50 nm was prepared.

### EXAMPLE 2

Nanometer calcium carbonate prepared in example 1 was prepared to a 0.8 mol/L suspension. 1000 ml of the nanometer calcium carbonate suspension was put into the reactor, and heating and agitating were started. The agitating speed was 400 to 500 rpm. 500 ml of 0.68 mol/L sodium silicate solution and 10% by weight diluted hydrochloric acid were prepared. When the temperature reached 80° C., the sodium silicate solution was added and at the same time the diluted hydrochloric acid was added to adjust the pH value of the system to between 8.5 and 9.5 to produce a CaCO₃/SiO₂ core-shell structure material. When all the sodium silicate solution was added to the system, we stopped adding the acid and stirred the solution for aging. The aging time was controlled within 4 hours to make the SiO₂ deposit and solidify on the surface of CaCO₃. The slurry after aging was filtrated, washed and dried at 105° C. for 12 h, then crashed and sieved by standard sieve of 250 mesh, and calcined in muffle furnace with a heating speed of 4° C./min, a calcining temperature of 600° C. to 700° C. ,and a calcining time of 360 min. Then the calcined powder was dissolved by 500 ml 20% by weight diluted hydrochloric acid with a dissolving time of 5 h at pH lower than 1 to remove the CaCO₃ template. Finally, after washing, filtrating, drying at 105° C. and sieving, the hollow silica particle was obtained.

### EXAMPLE 3

25 g PMMA which had a 40% by weight solid content was diluted with 200 ml deionized water and then transferred into a reactor entirely. 16.4 g tetraetoxysilane (TEOS) was added into the reactor firstly, then 20 g 35% by weight HCl was drop-wise added and stirred at room temperature in a stirring speed of 400 rpm. After reacting for 24 h with stirring, the mixture was filtrated, dried at 60° C. to 95° C., sieved and finally calcined at 400° C. to 500° C., and the hollow SiO₂ particle was obtained.

### EXAMPLE 4

Except for changes as follows, other conditions were the same as shown in example 3.

22 g PS that had a 45% by weight solid content was diluted with 200 ml deionized water and transferred into a reactor entirely. 16.4 g tetraetoxysilane (TEOS) was added into the reactor firstly, 200 ml 10% by weight HCl solution was then drop-wise added and stirred at room temperature with a stirring speed of 400 rpm. After reacting for 24 h with stirring, the mixture was filtrated, dried at 90° C. to 100° C., sieved and finally calcined at 400° C. to 500° C., and the hollow SiO₂ particle was obtained.

### EXAMPLE 5

Except for changes as follows, other conditions were the same as shown in example 3.

The filter cake of the single nanometer hollow SiO₂ particle obtained from example 2 was dispersed entirely with deionized water into a colloid at a concentration of 5 to 7% by weight, with a total volume of 200 ml, and then was transferred into the top of the oil-ammonia shaping tube (as shown in FIG. 3). The length of the tube was 1.5 m, the length ratio of oil and ammonia was 1:1, and the ratio was maintained by adding ammonia water into the tube at proper time. The size of the shaping particle and shaping rate were controlled by regulating the flux of the pump, which was usually controlled at 5 to 10 m/min. The time for a single SiO₂ colloid particle going through the oil phase and going down from the ammonia water phase was about 1 min. Then, after forming the shape by passing the oil and ammonia water phase, the shaped SiO₂ was collected at the bottom of the tube released from the faucet at the bottom. The primary principle of the oil-ammonia shaping method was the exciting of surface tension, which forced the pseudo sol to shrink and shape. After entering into the oil phrase, the liquid droplet of the pseudo sol shrank to shape depending on the surface contraction force of liquid, also known as surface tension. Therefore, the main function of the oil was to shape. The ammonia water phase was to gel the spherical sol which was down from the oil phrase by electrolyte (NH₄OH) and to solidify the globes hard sufficiently, so as to achieve solidification. The shaped SiO₂ was filtrated, dried at 105° C., screened with standard sieve of 100 mesh, and calcined in muffle furnace with a heat-ramp of 3° C./min, a calcining temperature of 450° C. and a calcining time of 240 min. The agglomerated SiO₂ particulate having an average diameter of 10 to 50 μm, a BET specific surface area of 100 to 400 m²/g, a pore diameter of 10 to 20 nm and a pore volume of 0.1 to 2.0 cm³/g can be obtained.

### EXAMPLE 6

Except for changes as follows, other conditions were the same as shown in example 2.

The single-nanometer hollow SiO₂ particle prepared in example 2 was dispersed entirely with ethanol to obtain a concentration of 10% by weight and a total volume of 200 ml, into which 30 ml of 1% by weight polyvinyl alcohol (PVA) was added. At the same time, the temperature was increased and a high pressure N₂ was introduced. When the temperature of inlet and outlet reached 120° C. and 170° C., respectively, the SiO₂ suspension was transported to the spray nozzle of the spray drier by pump with a flux of 50˜60 ml/min, and the particle size was adjusted by increasing the flux of N₂. The dried SiO₂ particle was transported into the cyclone separator by the high speed gas. The solid particle was separated by the cyclone separator and was let out from the bottom of the separator to give the agglomerated silica particulate. The size of the dried agglomerate SiO₂ particulate can be controlled by changing the concentration of SiO₂ suspension, the speed of feeding materials, the rate of N₂ and the drying temperature.

### EXAMPLE 7

Except for changes as follows, other conditions were the same as shown in example 3.

In order to remove the little amount of water and oxygen contained, toluene and dichloromethane were purified by reflux distillation method. 5 g sodium was cut into small pieces and put into a 1000 ml dried flask, and then 500 ml toluene was put into the flask for reflux distillation purification. The distillation temperature was 110° C. to 120° C. and the reflux time was 5 to 8 h. 5 g calcium hydride solid was put into a 1000 ml dried flask, and 500 ml dichloromethane was put into the flask for reflux distillation purification. The distillation temperature was 30° C. to 45° C. and the reflux time was 5 to 8h. 20 ml MAO solution at a concentration of 1.4 mol/1 was diluted with 50 ml toluene to prepare the diluted MAO solution. 2 g dried SiO₂ support, which was prepared in example 2, was put into the diluted MAO solution and impregnated at 50° C. to 60° C. for 5 to 6 h. After impregnation, the SiO₂ was washed with toluene to remove the extra unsupported MAO, and dried in vacuum drying oven. 0.05 g nometallocene catalyst was dissolved and diluted with 50 ml dichloromethane and then used to impregnate 1.5 g SiO₂ support prepared above with a impregnating temperature of 50° C. to 60° C. and a impregnating time of 5 to 6 h. After impregnation, it was washed with dichloromethane until the extra nonmetallocene-metallocene iron catalyst was removed, and then dried in vacuum drying oven after separated. The catalyst-loading SiO₂ was thus prepared.

34.5 mg supported nonmetallocene catalyst prepared above was put into a 2000 ml reaction pot to react for 2 h with a reaction pressure of 2 MPa and a temperature of 60° C. to 80° C. 199 g polymer was obtained by the polymerization reaction and the total activity was 5768 times, and the stack density was 0.23 g/ml. The shape of the polymer particle was very good with a primary size between 0.7 and 0.8 mm. No low molecular weight polyethylene wax was found. The produced polyethylene PE has a molecular weight distribution of 2.77, a melting temperature of 136.4° C. and a molecular weight of 6.54×10⁵ to 12.3×10⁵.

### EXAMPLE 8

Except for changes as follows, other conditions were the same as shown in example 7.

30 ml MAO solution with a concentration of 1.4 mol/l was diluted with 50 ml toluene to prepare the diluted MAO solution. 2 g dried SiO₂ support, which was prepared in example 2, was put into the diluted MAO solution and impregnated at 50° C. to 60° C. for 4 to 5 h. After impregnation, the SiO₂ was washed with toluene to remove the extra unsupported MAO, and then dried in vacuum drying oven. 0.1 g metallocene catalyst of metallocene-Zr catalyst was dissolved and diluted with 50 ml dichloromethane to impregnate 1.5 g SiO₂ support prepared above at an impregnating temperature of 40° C. to 50° C. for 4 to 5 h. After impregnation, it was washed with dichloromethane until the extra metallocene catalyst was removed and then dried in vacuum drying oven after separated. The catalyst-loading SiO₂ was thus prepared.

### EXAMPLE 9

Except for changes as follows, other conditions were the same as shown in example 7.

20 mg supported catalyst, 2 ml methyl aluminum oxyalkane MAO (15% by weight) and 600 g hexane solvent were put into a 2000 ml polymerization reaction pot with a circling water temperature of 60° C., a stirring rate of 500 r/min and an ethene pressure of 2.0 MPa. The polymerization reaction was carried out by using sullage polymerization techniques with a reaction time of 8 h. After the reaction, the product was filtrated, washed and dried. The product of polyethylene PE was obtained.

We claim:

1. A silica particle having a hollow structure and a substantially spherical morphology, and a specific surface area from 500 to 1500 m²/g.

2. The silica particle according to claim 1 wherein the specific surface area is from 500 to 1000 m²/g.

3. The silica particle according to claim 1, further having a pore volume from 0.01 to 2.0 ml/g, and a grain size from 30 to 500 nm.

4. The silica particle according to claim 3, wherein the pore volume is from 0.2 to 1.5 ml/g, and the grain size is from 40 to 100 nm.

5. A process for preparing a hollow-structured silica particle, comprising the steps of:
a) providing a template particle suspension comprising particles selected from the group consisting of calcium carbonate particles, polymethylmethacrylate particles, polystyrene particles, polyurethane particles, and mixtures thereof;
b) mixing the particle suspension with an amount of a silicon-containing solution selected from a silicon-containing aqueous solution and an organic compound of silicon;
c) stirring the resultant solution continuously to react the template particles and the silicon-containing solution for a time at a controlled temperature and pH, and optionally aging for a period of time, to form an particle product having a core-shell structure consisting of a coating layer of SiO₂ as a shell and the template particle as a core;
d) filtering the aged mixture, and washing and drying the particle product to produce a composite material with the core-shell structure; and
e) calcining the composite material, and optionally dissolving in acid if the template particle is calcium carbonate, then washing and drying the calcinated particles to produce the hollow-structured silica particle.

6. The process according to claim 5, wherein the calcium carbonate particle size is less than 100 nm, the polymethylmethacrylate particle size and polystyrene particle size is from 100 nm to 400 nm, and polyurethane particle size is from 30 nm to 100 nm.

7. The process according to claim 6, wherein the calcium carbonate particle size is from 30 nm to 50 nm; the polymethylmethacrylate particle size and polystyrene particle size is from 200 nm to 300 nm, and the polyurethane particle size is from 40 nm to 60 nm.

8. The process according to claim 5, wherein the calcium carbonate particle has a substantially spherical or cubic shape, and the polymethylmethacrylate particle, the polystyrene particle and the polyurethane particle have a substantially spherical shape.

9. The process according to claim 5, wherein the silicon-containing aqueous solution is selected from the group consisting of an aqueous solution of a water-soluble silicate and an organic silicon ester that can be hydrolyzed to silica.

10. The process according to claim 9, wherein the water-soluble silicate is selected from Na₂SiO₃, K₂SiO₃, and a mixture thereof, and the organic silicon ester is tetraethyl orthosilicate (TEOS).

11. The process according to claim 5, wherein the temperature is from 20° C. to 100° C. and the pH value of the reaction system is from 5 to 13.

12. The process according to claim 5, wherein the reaction time is from 1 hour to 24 hours, the aging time is 0 hour to 10 hours, the calcining temperature is from 400° C. to 800° C., and the calcining time is 1 hour to 10 hours.

13. The process according to claim 5, wherein in the step to dissolve the composite material in acid after calcination, the pH value is less than 1 and the dissolving time is from 2 hours to 10 hours.

14. An agglomerated hollow silica particulate composed of a plurality of nanometer-sized hollow silica, having a specific surface area of 50 to 600 m²/g.

15. The agglomerated hollow silica particulate according to claim 14 wherein the specific surface area is 100 to 400 m²/g.

16. The agglomerated hollow silica particulate according to claim 14, having a pore volume from 0.1 ml/g to 4 ml/g, a pore diameter from 4 nm to 30 nm, and a grain size from 5 μm to 70 μm.

17. The agglomerated hollow silica particulate according to claim 16, wherein the pore volume is from 0.1 ml/g to 2 ml/g, the pore diameter is from 10 nm to 40 nm, and the grain size is from 10 μm to 50 μm.

18. The use of the agglomerated hollow silica particulate according to claim 14 as a catalyst support in an alkene polymerization.

19. The use of the agglomerated hollow silica particulate according to claim 16 as a catalyst support in an alkene polymerization.

20. The use of the agglomerated hollow silica particulate according to claim 17 as a catalyst support in an alkene polymerization.
